(19) United States
(12) Patent Application Publication
(10) Pub. No.: US 2006/0089967 A1
(43) Pub. Date: Apr. 27, 2006

(54) Secure multi-user web hosting

(75) Inventors: Andi Gutmans, Herzlia (IL); Zeev Suraski, Givatayim (IL)

Correspondence Address: DARBY & DARBY P.C., P. O. BOX 5257, NEW YORK, NY, 10150-5257, US

(73) Assignee: ZEND TECHNOLOGIES LTD., Ramat Gan (IL)

(21) Appl. No.: 11/225,555

(22) Filed: Sep. 12, 2005

Related U.S. Application Data
(60) Provisional application No. 60/622,506, filed on Oct. 26, 2004.

(51) Int. Cl. G06F 15/16

(52) U.S. Cl. 709/203

(57) ABSTRACT

A web server is able to efficiently host multiple web sites. Since overhead is significantly reduced, the server can accommodate a large number of concurrent users without service delays or disruptions, even under heavy load conditions. A persistent controller process executes on the server, and responsively to a user request for access to a resource of one of the clients, a child process is spawned. The user request is then served using the child process.

### CROSS-REFERENCE TO RELATED APPLICATIONS

This application claims priority from Provisional Application No. 60/622,506, filed Oct. 26, 2004, which is herein incorporated by reference.

### BACKGROUND OF THE INVENTION

1. Field of the Invention

This invention relates to computer systems intended for high performance shared web hosting. More particularly, this invention relates to web servers that can host multiple web sites efficiently, while maintaining data security on the servers.

2. Description of the Related Art

The Internet and World Wide Web (web) constitute a set of interconnected computer networks that can be used to access a growing amount and variety of information. The web is a distributed system, and functions as a client-server based information presentation system. Information that is intended to be accessible over the web is stored in the form of “pages” on computers known as servers or web servers. Users can access a web page using general purpose computers, referred to as clients, by specifying the uniform resource locator (URL) of the page.

When a client specifies a URL, located in a web site, a part of the URL, known as the domain name, is passed to a domain server to be translated to a network address. The network address specifies the Internet Protocol (IP) address of the intended server. The client request is passed to the server having the network address. The server uses the path name in the URL to locate the web page requested by the client. A copy of the web page is then sent to the client for viewing by the user.

In modern web-based computer systems, a web server is capable of hosting multiple web sites. However, under heavy load conditions, web site service delays occur. Indeed, there may be interruptions seen by current users, and new users of the site may be rejected.

### SUMMARY OF THE INVENTION

According to disclosed embodiments of the invention a web server is able to efficiently host multiple web sites. Overhead is significantly reduced, enabling the server to accommodate a large number of concurrent users without service delays or disruptions, even under heavy load conditions.

The invention provides a method of hosting multiple clients on a server that is connected to a data network, which is carried out by establishing a persistent controller process on the server, and responsively to a browser request of a user for access to a resource of one of the clients, spawning a child process of the controller process, and serving the browser request using the child process.

One aspect of the method includes associating a user identification of the child process with the one client, and limiting access of the child process to a predefined memory area of the one client.

According to another aspect of the method, the controller process has supervisory privileges.

The invention provides a computer software product, including a computer-readable medium in which computer program instructions are stored, which instructions, when read by a computer, cause the computer to perform a method for hosting multiple clients on a server that is connected to a data network, which is carried out by establishing a persistent controller process on the server, and responsively to a browser request of a user for access to a resource of one of the clients, spawning a child process of the controller process, and serving the browser request using the child process.

The invention provides a data processing system of hosting multiple clients on a server that is connected to a data network. The server has reserved resources for each of the clients, and is operative to establish a persistent controller process. Responsively to a browser request of a user for access to a resource of one of the clients, the server is operative for spawning a child process of the controller process, and serving the browser request using the child process.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a block diagram showing a typical configuration for a hosting web server, in accordance with a disclosed embodiment of the invention;

FIG. 2 is a block diagram of another arrangement, in which a host site provider shares hardware among many networked web servers and storage devices in accordance with a disclosed embodiment of the invention; and

FIG. 3 is a flow diagram illustrating a method of secure web hosting in accordance with a disclosed embodiment of the invention.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code, which embodies aspects of the present invention, is typically maintained in permanent storage, such as a computer readable medium. In a client-server environment, such software programming code may be stored on a client or a server. The software programming code may be embodied on any of a variety of known media for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. For example, the transmission medium may include a communications network, such as the Internet. In addition, while the invention may be embodied in computer software, the functions necessary to implement the invention may alternatively be embodied in part or in whole using hardware components such as application-specific integrated circuits or other hardware, or some combination of hardware components and software.

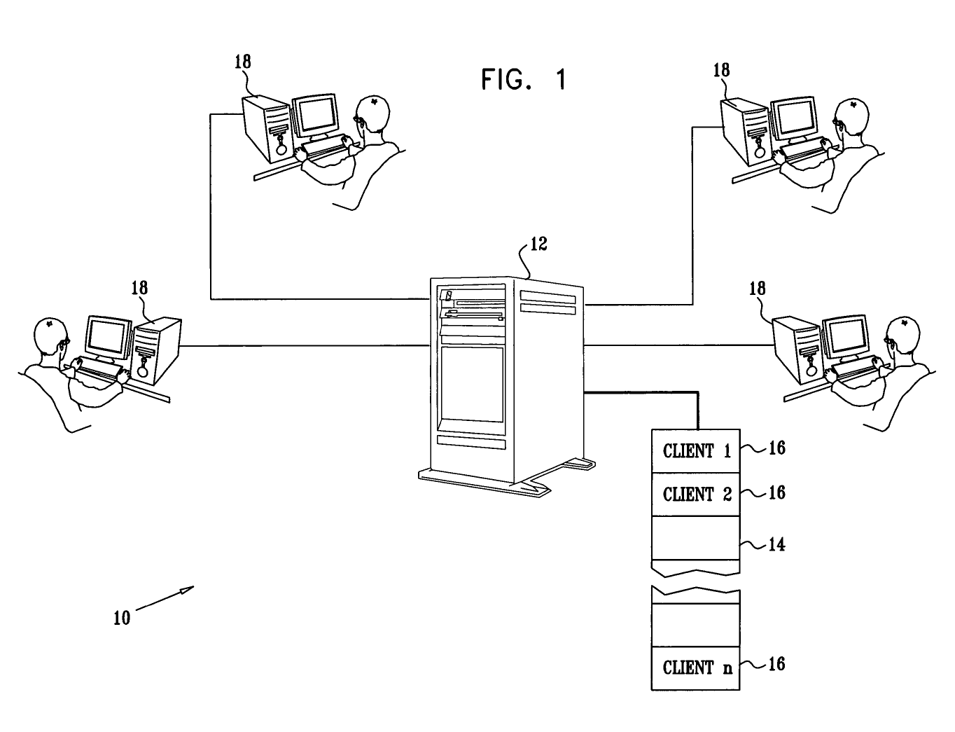

Turning now to the drawings, reference is initially made to FIG. 1, which is a block diagram showing a typical configuration 10 for a hosting web server 12, in accordance with a disclosed embodiment of the invention. The server 12 has a memory 14, which has allocations for a plurality of clients 16. The server 12 is accessed over a data network such as the Internet by several customers or users 18, sequentially or concurrently in different combinations. The users 18 may desire to access the memory areas of the same or different clients 16 in various combinations. For purposes of data security it is essential that no customer of one client be permitted to access data that is stored in memory reserved for another client. Also, no client may access memory of another client without authorization.

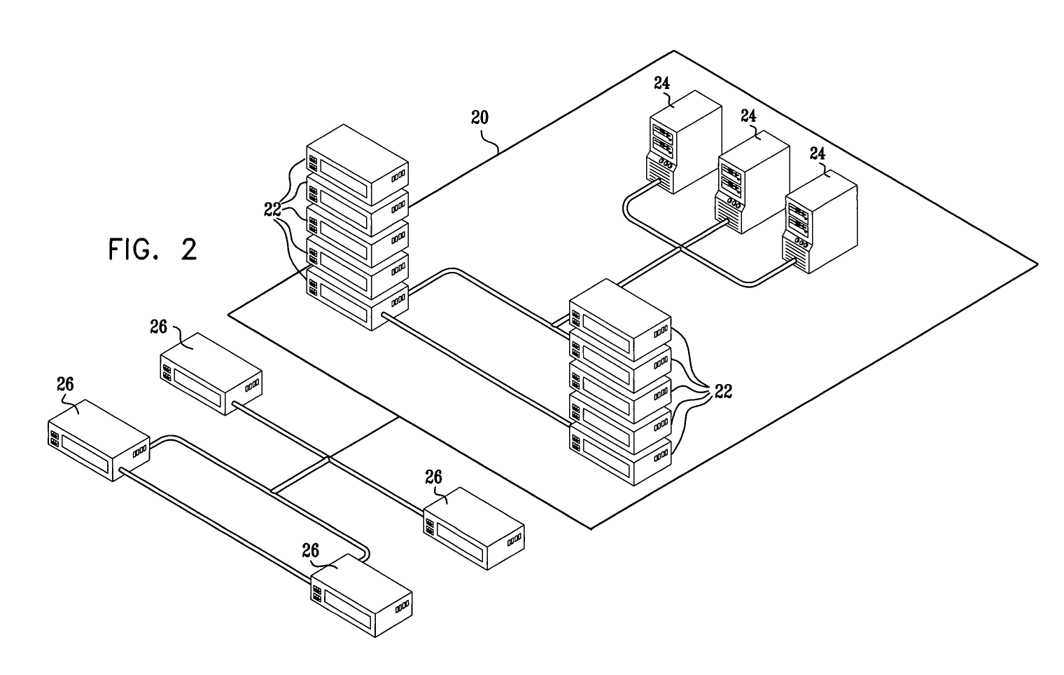

Reference is now made to FIG. 2, which is a block diagram of another arrangement, in which a host site provider 20 shares hardware among many networked web servers 22 and storage devices 24 in accordance with a disclosed embodiment of the invention. The arrangement, while more complex than that shown in FIG. 1, is transparent to a plurality of users 26. However, its administration is more involved, and involves more detailed considerations of load balancing in addition to providing rapid and secure access. One or more memories (not shown) within the web servers and storage devices are reserved for particular clients as described above.

Typically, the web servers 22 employ software such as the Apache web server, available from Red Hat, Inc., 2600 Meridian Parkway, Durham, N.C. 27713 in combination with scripts that run on a PHP:hypertext preprocessor (PHP). The Zend Engine, available from Zend Technologies Ltd., P.O. Box 3619, Ramat Gan, Israel, 52136 is suitable for use as the preprocessor.

In the past, assuring secure access by users of the arrangements shown in FIG. 1 and FIG. 2 has involved overhead, leading to relatively poor performance. For example, the Common Gateway Interface (CGI) protocol spawns an external process for each user that accesses a client's hosted site. This is typically combined with calls to methods such as chroot( ) and setuid( ). The approach is secure, as it exploits the security features of the operating system. A typical CGI sequence is shown in Listing 1. The overhead is high, partly due to the need to invoke kernel functions such as exec( ).

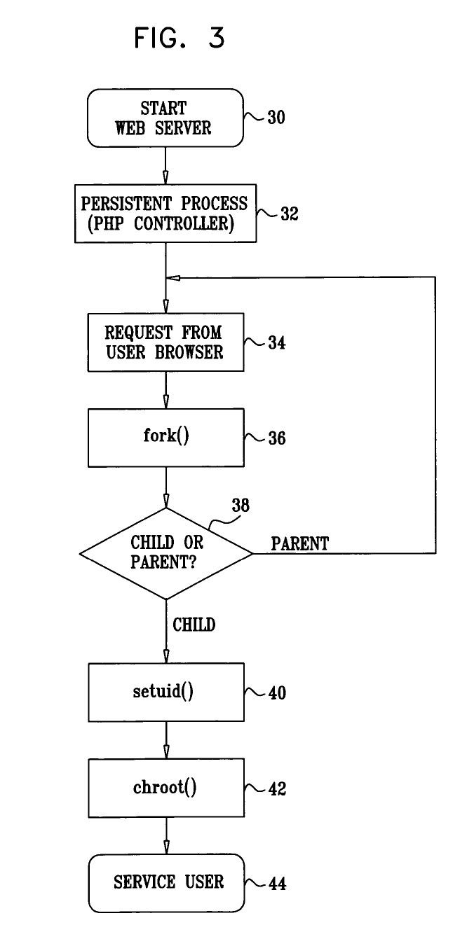

Reference is now made to FIG. 3, which is a flow diagram illustrating a method of secure web hosting in accordance with a disclosed embodiment of the invention. This method not only is more rapid than the conventional sequence shown in Listing 1, but also allows a greater degree of resource sharing among users, an objective that is difficult to accomplish using standard Apache software.

The method begins at initial step 30, in which a web server is initiated, and necessary control software loaded, such as a PHP script engine.

Control passes immediately to step 32. A persistent process is spawned by the web server, which is a PHP controller, having root or supervisory privileges. As is explained below, child processes of the persistent process are employed to service browser requests from users. This process typically sleeps until it is signaled that a user request is pending.

Next, at step 34, a browser request is received from a user. The persistent process responds in step 36 by duplicating itself using a fork( ) call. This call is relatively inexpensive in terms of computer resources, as compared to calls such as exec( ). As will be apparent to those skilled in the art, it is a simple matter to identify the parent and child processes that exist following return from the fork( ) invocation. In the explanation that follows, the actions taken by the two processes are shown as separate actions on the flow chart for convenience of presentation, it being understood that they actually execute concurrently.

Next, at decision step 38, it is determined which of the processes resulting from the fork( ) call is the parent and which is the child. Control with respect to the parent returns to step 34 to await another browser request.

The child process proceeds to step 40 where its user identification is set with respect to the client for which access to reserved space is being sought. Then, at step 42, access to memory is limited to the client's space by a call to chroot( ). The child process inherits the ability of the parent to access shared resources on the server other than reserved memory.

Next, at final step 44, the child process continues to execute in order to service the browser request.

A high level description of the method disclosed above with respect to FIG. 3 is given in Listing 2. A more detailed description is presented in Listing 3.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

COMPUTER PROGRAM LISTINGS

```
                        Listing 1
    fork( )
    exec( )
    setuid( )
    chroot( ).
                        Listing 2
Plugin:
  startup( )
  {
  pipe = create_pipe( )
  if (fork( ) == 0) {
..
  } else {
..
  }
  }
  handle_request(request, user_id, group_id, dir)
  {
  send_message_to_PHP_controller(request, user_id,
  group_id, dir) }
  send_message_to_PHP_controller(request, user_id,
  group_id, dir) {
    write(pipe,...)
    ..
  }
  PHP Controller:
...
                        Listing 3
ZendFastCGI:
===========
function startup( ) {
if (fork( ) == 0) {
  pm_main( )
  }
}
function pm_main( ) {
  foreach (static_processes as binding) {
  for (i = 0; i < binding.start_processes; i++) {
    p = pm_launch_process(binding)
    processes[p.pid] = p;
  }
  }
  while (1) {
  pid = wait( );
  p = processes[pid];
  binding = p.binding;
  binding.count−−;
  unset(processes[pid]);
  for (i = binding.count; i < binding.start_processes;
    i++) {
  p = pm_launch_process(binding)
  processes[p.pid] = p;
  }
  }
}
function pm_launch_process(binding) {
  if (!binding.socket) {
  pm_make_socket(binding);
  }
  pid = fork( );
  if (pid == 0) {
  dup2(binding.socket, stdin);
  exec(binding-command_line);
  }
  binding.count++;
  p = new Process( );
  p-binding = binding;
  p-pid = pid;
  return p;
}
function process_request(request) {
  binding = find_binding(request);
  if (binding.socket) {
  pipe = connect(binding.socket);
  request.environment.add_var(”FCGI_EXTENDED_USER”,
    request.uid);
  request.environment.add_var(”FCGI_EXTENDED_GROUP”,
    request.gid);
  request.environment.add_var(”FCGI_EXTENDED_ROOT”,
      request.root);
  write(pipe,request);
  response = read(pipe);
  close(pipe);
  return response;
  } else {
  error( );
  }
}
PHP:
===
function main( ) {
  running = 0;
  children =getenv(”PHP_FCGI_CHILDREN”);
  while (1) {
  while(running < children) {
  if (fork( ) == 0) {
    request = read(stdin);
    setgid(request.
      environment.get_var(”FCGI_EXTENDED_GROUP”));
    chroot(request.environment.get_var
      (”FCGI_EXTENDED_ROOT”));
    setuid(request.environment.get_var
      (”FCGI_EXTENDED_USER”));
    response = php_process_request(request);
    write(stdout, response);
    exit( );
  }
    running++;
  }
  wait( );
  running−−;
  }
}
```

1. A method of hosting multiple clients on a server that is connected to a data network, comprising the steps of:
establishing a persistent controller process on said server;
responsively to a browser request of a user for access to a resource of one of said clients, spawning a child process of said controller process; and
serving said browser request using said child process.

2. The method according to claim 1, further comprising the steps of:
associating a user identification of said child process with said one client; and
limiting access of said child process to a predefined memory area of said one client.

3. The method according to claim 1, wherein said controller process has supervisory privileges.

4. A computer software product, including a computer-readable medium in which computer program instructions are stored, which instructions, when read by a computer, cause the computer to perform a method for hosting multiple clients on a server that is connected to a data network, comprising the steps of:
establishing a persistent controller process on said server;
responsively to a browser request of a user for access to a resource of one of said clients, spawning a child process of said controller process; and
serving said browser request using said child process.

5. The computer software product according to claim 4, wherein said computer is further instructed to perform the steps of:
associating a user identification of said child process with said one client; and
limiting access of said child process to a predefined memory area of said one client.

6. The computer software product according to claim 4, wherein said controller process has supervisory privileges.

7. A data processing system of hosting multiple clients on a server that is connected to a data network, said server having reserved resources for each of said clients, and being operative to perform the steps of:
establishing a persistent controller process;
responsively to a browser request of a user for access to a resource of one of said clients, spawning a child process of said controller process; and
serving said browser request using said child process.

8. The data processing system according to claim 7, wherein said server is further operative to perform the steps of:
associating a user identification of said child process with said one client; and
limiting access of said child process to a predefined memory area of said one client.

9. The data processing system according to claim 7, wherein said controller process has supervisory privileges.
